(19) United States
(12) Patent Application Publication
(10) Pub. No.: US 2026/0016044 A1
(43) Pub. Date: Jan. 15, 2026

(54) ATTACHMENT DEVICE

(71) Applicant: Quarry Trail, LLC, Salt Lake City, UT (US)

(72) Inventor: David Alonzo Rupp, Salt Lake City, UT (US)

(21) Appl. No.: 18/773,270

(22) Filed: Jul. 15, 2024

(51) Int. Cl. F16B 45/00; A44B 15/00; F16B 45/02

(52) U.S. Cl. CPC F16B 45/002; A44B 15/002; F16B 45/023; F16B 2200/83

(57) ABSTRACT

A magnetic attachment device may be used to attach a variety of items to a variety of attachment points. A magnetic attachment device may include a first portion that is configured to be attached to an attachment point and a second portion that is configured to secure one or more items. The first and second portions may be selectively coupled via magnetic force. The first and second portions may be configured to require the second portion to be rotated outwardly away from the first portion to decouple from the first portion.

### BRIEF SUMMARY

The present disclosure relates to an attachment device that may be used to attach a variety of items to a variety of attachment points. An attachment device may include a first portion that is configured to be attached to an attachment point and a second portion that is configured to secure one or more items. The first and second portions may be selectively coupled such as by magnetic force. The first and second portions may be configured to require the second portion to be rotated outwardly away from the first portion to decouple from the first portion.

In some embodiments, an attachment device may include a first portion having a first attachment portion, a first coupling portion, and a first intermediate portion that forms an opening between the first attachment portion and the first coupling portion. The attachment device may also include a second portion having a second attachment portion, a second coupling portion, and a second intermediate portion that spaces the second attachment portion from the second coupling portion. The second portion may further include a decoupling portion. The second coupling portion may insert into the opening to couple with the first coupling portion. The decoupling portion may be configured to decouple the second coupling portion from the first coupling portion via a rotational force.

In some embodiments, the first coupling portion may include a first magnet and the second coupling portion may include a second magnet. The first and second magnets may couple the first and second coupling portions together.

In some embodiments, the decoupling portion may include an arm.

In some embodiments, the arm may be curved.

In some embodiments, the second intermediate portion may contact the first coupling portion when a force is applied to the arm to thereby cause the rotational force to rotate the second coupling portion away from the first coupling portion.

In some embodiments, the first attachment portion may form a loop.

In some embodiments, the second attachment portion may form a loop.

In some embodiments, the first intermediate portion may include opposing arms.

In some embodiments, the second intermediate portion may be offset from a longitudinal axis of the second coupling portion and second attachment portion.

In some embodiments, the second intermediate portion may be configured to receive the first coupling portion when the second coupling portion is coupled to the first coupling portion.

In some embodiments, the first coupling portion may include a first magnet that faces the first attachment portion and the second coupling portion may include a second magnet that faces the second attachment portion.

In some embodiments, an attachment device may include a first portion having a first attachment portion, a first coupling portion housing a first magnet, and a first intermediate portion that forms an opening between the first attachment portion and the first coupling portion. The attachment device may also include a second portion having a second attachment portion, a second coupling portion housing a second magnet, and a second intermediate portion that spaces the second attachment portion from the second coupling portion. The second coupling portion may insert into the opening to couple the second magnet to the first magnet to thereby couple the second portion to the first portion.

In some embodiments, the second attachment portion may be positioned below the second coupling portion. The second portion may also include a decoupling portion that includes an arm that extends outwardly from the second coupling portion.

In some embodiments, the arm may be curved upwardly.

In some embodiments, the second intermediate portion may be configured to contact the first coupling portion when a downward force is applied to the arm.

In some embodiments, the first and second attachment portions may each form a loop.

In some embodiments, an attachment device may include a first portion having a first attachment portion, a first coupling portion, and a first intermediate portion that forms an opening between the first attachment portion and the first coupling portion. The attachment portion may also include a second portion having a second attachment portion, a second coupling portion, and a second intermediate portion. The opening may be configured to receive the second coupling portion to enable the second coupling portion to couple to the first coupling portion. The second intermediate portion may be configured to receive the first coupling portion when the second coupling portion is coupled to the first coupling portion.

In some embodiments, the first coupling portion may include a first magnet and the second coupling portion may include a second magnet.

In some embodiments, the second portion may include a decoupling portion having an arm that causes the second coupling portion to rotate away from the first coupling portion when a force is applied to the arm.

In some embodiments, the arm may extend from the second coupling portion.

This summary is provided to introduce a selection of concepts in a simplified form that are further described below in the Detailed Description. This summary is not intended to identify key features or essential features of the claimed subject matter.

### BRIEF DESCRIPTION OF THE DRAWINGS

Understanding that these drawings depict only typical embodiments of the present disclosure and are not therefore to be considered limiting of its scope, the present disclosure will be described and explained with additional specificity and detail through the use of the accompanying drawings in which:

FIGS. 1A and 1B are perspective views of an attachment device when coupled and decoupled respectively in accordance with one or more embodiments;

FIGS. 2A and 2B are side views showing how the first portion of an attachment device decouples from the second portion of the attachment device in accordance with one or more embodiments; and

FIG. 3 provides an example of how an attachment device configured in accordance with one or more embodiments can be used to secure keys.

### DETAILED DESCRIPTION

In this specification and the claims, the term “attachment point” should be construed broadly to encompass anything to which an attachment device may reasonably be attached. Common examples of attachment points include portions of clothing or gear worn by an individual. Directional references are relative and are based on the assumption that an attachment device is used in the vertical orientation shown in the figures. However, an attachment device configured in accordance with one or more embodiments could be used, or configured to be used, in different orientations.

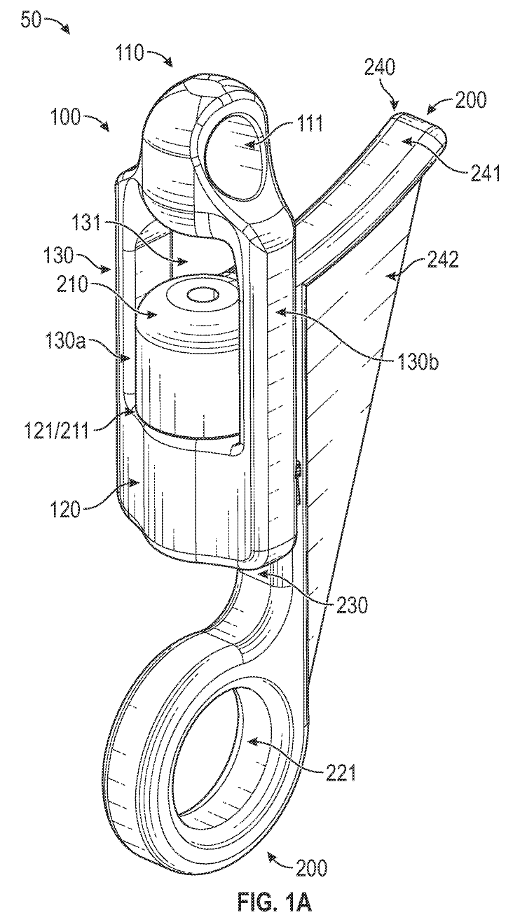

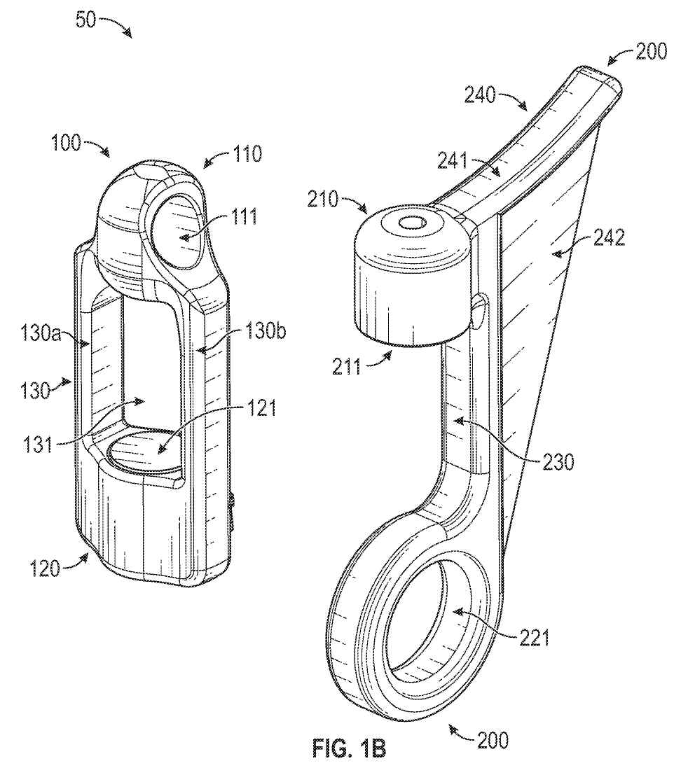

FIGS. 1A and 1B are perspective views of an attachment device 50 when coupled and decoupled respectively in accordance with one or more embodiments. Attachment device 50 includes a first portion 100 and a second portion 200 that may be selectively coupled such as via magnetic force.

First portion 100, which may typically be the upper portion, includes or forms a first attachment portion 110 by which attachment device 50 may be secured to an attachment point. In the depicted embodiments, first attachment portion 110 forms a loop 111 which could receive a carabiner or other separate coupling mechanism. In other embodiments, first attachment portion 110 could include or form a hook or any other suitable fastening structure, material, or component (e.g., a magnet, a snap, hook and loop, reusable adhesive, etc.) so that magnetic attachment device 50 may be secured to any suitable attachment point.

First portion 100 also includes a first coupling portion 120 that is spaced from first attachment portion 110 by a first intermediate portion 130 that forms an opening 131 between first attachment portion 110 and first coupling portion 120. In the depicted embodiment, first intermediate portion 130 includes opposing arms 130a, 130b that extend between opposing sides of first attachment portion 110 and first coupling portion 120. In other embodiments, first intermediate portion 130 could include a single arm, one or more walls, or any other structure or mechanism that maintains opening 131. In some embodiments, first coupling portion 120 includes a first magnet 121 that extends to (or at least sufficiently towards) opening 131 to enable the magnetic coupling described below.

Second portion 200, which may typically be the lower portion, includes a second coupling portion 210 that is configured to insert into opening 131. In the depicted embodiment, second coupling portion 210 has a cylindrical shape but any other suitable shape could be used including shapes that are adapted to a particular configuration of first intermediate portion 130 and/or opening 131.

In some embodiments, second coupling portion 210 includes a second magnet 211 that is oriented towards first magnet 121 when second coupling portion 210 is positioned in opening 131. In such embodiments, first magnet 121 and second magnet 211 couple first portion 100 and second portion 200 together. In some embodiments, the respective faces of first magnet 121 and second magnet 211 may be exposed and may contact one another to maximize the magnetic force. In other embodiments, one or both of first magnet 121 and second magnet 211 could be recessed or embedded within first coupling portion 120 and second coupling portion 210 respectively.

Second portion 200 also includes a second attachment portion 220 that is spaced from second coupling portion 210 by a second intermediate portion 230. Second intermediate portion 230 can be configured to receive first coupling portion 120 such as by being offset relative to a longitudinal axis of second coupling portion 210 and second attachment portion 220 as shown in the depicted embodiments.

In the depicted embodiments, second attachment portion 220 forms a loop 221 which could be used to secure a variety of items such as a key ring, nippers, scissors, pliers, hemostats, fishing accessories, etc. In other embodiments, second attachment portion 220 could include or form a hook or any other suitable fastening structure, material, or component (e.g., a magnet, a snap, hook and loop, reusable adhesive, etc.) so that any suitable item or items could be secured to attachment device 50.

Second portion 200 further includes a decoupling portion 240 which the individual uses to decouple second portion 200 from first portion 100. Decoupling portion 240 includes an arm 241 that extends from second coupling portion 210. In some embodiments, including the depicted embodiments, arm 241 may extend in the same direction in which second intermediate portion 230 is offset from second coupling portion 210. More particularly, arm 241 may extend in the same (or similar) direction as the direction in which second coupling portion 210 must be withdrawn from opening 131. In other embodiments, arm 241 may extend in other directions so long as the rotational decoupling motion described below can be performed.

In some embodiments, arm 241 may be curved in a direction that is away from magnet 211 (or other coupling mechanism). In other words, assuming attachment device 50 is used in the depicted vertical orientation, arm 241 may be curved upwardly as it extends outwardly away from second coupling portion 210. This curved configuration can facilitate the rotational decoupling motion. In some embodiments, including the depicted embodiments, decoupling portion 240 may include or form a wing 242 that extends from arm 241 to second intermediate portion 230 and possibly to second attachment portion 220. In some embodiments, wing 242 may reinforce arm 241 and/or second attachment portion 220.

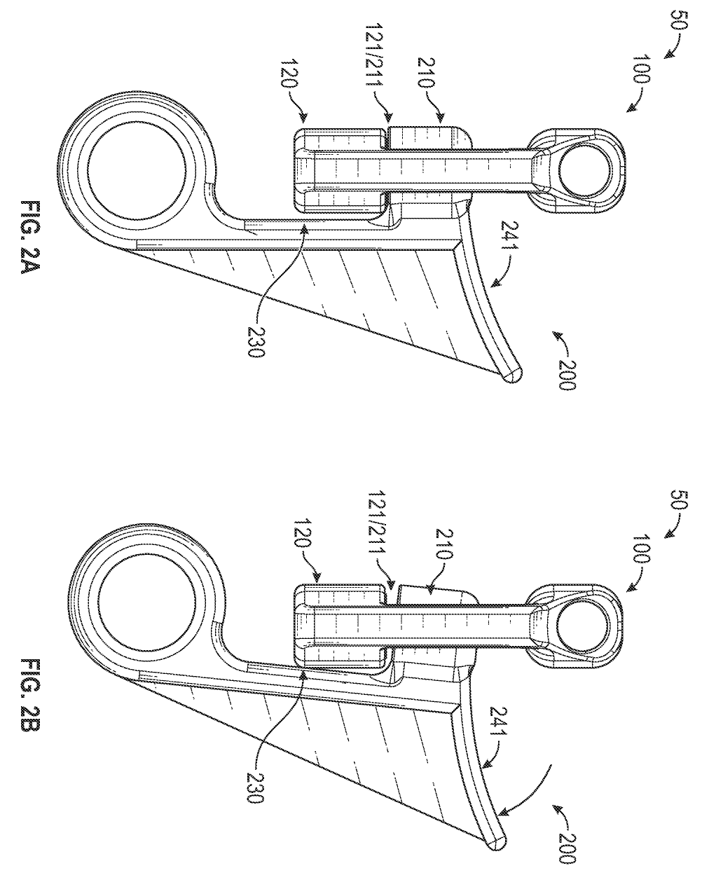

FIGS. 2A and 2B show how second portion 200 can be decoupled from first portion 100 using a rotational decoupling motion in accordance with one or more embodiments. In FIG. 2A, second coupling portion 210 has been inserted into opening 131 so that magnets 121 and 211 (or other coupling mechanisms) are in contact and thereby hold first portion 100 and second portion 200 together. Because second coupling portion 210 is above first coupling portion 120, second portion 200 cannot be decoupled from first portion 100 via a downward force. Similarly, the configuration of first intermediate portion 130 and second intermediate portion 230 in the depicted embodiments allow second portion 200 to be decoupled from first portion only in a single direction (e.g., to the right in FIGS. 2A and 2B). Furthermore, the strong magnetic force between magnets 121 and 211 makes it difficult to simply slide second portion 200 away from first portion 100.

As represented by the arrow in FIG. 2B, the individual must apply a downward force on arm 241 which, due to the curving configuration of arm 241 and the contact between second intermediate portion 230 and first coupling portion 120, applies a rotational force to second coupling portion 210 to lift second magnet 211 away from first magnet 121. Arm 241 increases the torque of this rotational force to facilitate decoupling. Notably, to successfully apply this rotational force, the individual would typically need to grasp or secure first portion 100 while applying the downward force on arm 241 (e.g., to prevent the entire attachment device 50 from moving in response to the force on arm 241). As a result, it is unlikely that second portion 200 would unintentionally decouple from first portion 100.

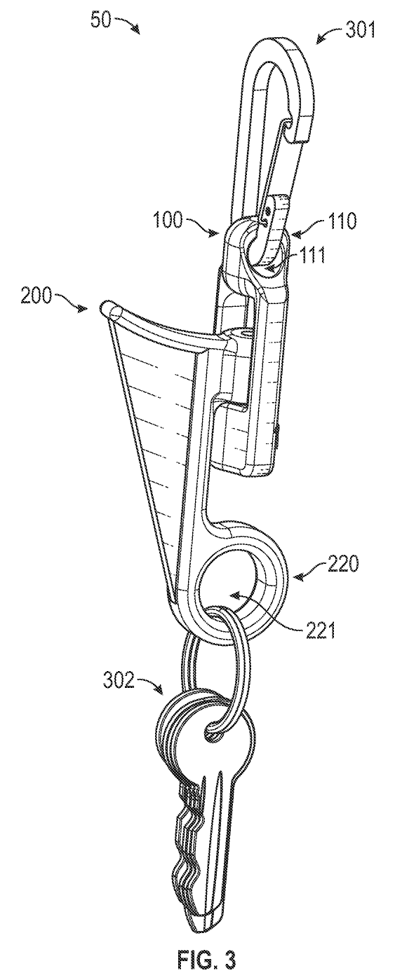

FIG. 3 provides an example of how an attachment device 50 could be used in one or more embodiments. As shown, a carabiner 301 could be inserted through loop 111 of first attachment portion 110 to allow attachment device 50 to be hung from a belt loop or another portion of an individual’s clothing or gear or to be attached to any other suitable structure. A key ring 302 is also connected to loop 221 of second attachment portion 220. To use any of the keys, the individual can remove second portion 200 using the rotational force described above. After using the keys, the individual can insert second coupling portion 210 back into opening 131 to again couple second portion 200 to first portion 100.

As suggested above, in some embodiments, magnets 121 and 221 could be replaced with other types of fasteners such as hook and loop, reusable adhesives, interlocking structural components, etc. In such embodiments, the same rotational force can be used to decouple second portion 200 from first portion 100.

Any of the above-described features can be used on any embodiment of an attachment device that is configured in accordance with the present disclosure. In particular, no feature or combination of features should be limited to any of the embodiments depicted in the figures.

What is claimed:

1. An attachment device comprising:
a first portion comprising a first attachment portion, a first coupling portion, and a first intermediate portion that forms an opening between the first attachment portion and the first coupling portion; and
a second portion comprising a second attachment portion, a second coupling portion, and a second intermediate portion that spaces the second attachment portion from the second coupling portion, the second portion further comprising a decoupling portion;
wherein the second coupling portion inserts into the opening to couple with the first coupling portion, and wherein the decoupling portion is configured to decouple the second coupling portion from the first coupling portion via a rotational force.

2. The attachment device of claim 1, wherein the first coupling portion includes a first magnet and the second coupling portion includes a second magnet, and wherein the first and second magnets couple the first and second coupling portions together.

3. The attachment device of claim 1, wherein the decoupling portion comprises an arm.

4. The attachment device of claim 3, wherein the arm is curved.

5. The attachment device of claim 4, wherein the second intermediate portion contacts the first coupling portion when a force is applied to the arm to thereby cause the rotational force to rotate the second coupling portion away from the first coupling portion.

6. The attachment device of claim 1, wherein the first attachment portion forms a loop.

7. The attachment device of claim 1, wherein the second attachment portion forms a loop.

8. The attachment device of claim 1, wherein the first intermediate portion comprises opposing arms.

9. The attachment device of claim 1, wherein the second intermediate portion is offset from a longitudinal axis of the second coupling portion and second attachment portion.

10. The attachment device of claim 1, wherein the second intermediate portion is configured to receive the first coupling portion when the second coupling portion is coupled to the first coupling portion.

11. The attachment device of claim 1, wherein the first coupling portion includes a first magnet that faces the first attachment portion and the second coupling portion includes a second magnet that faces the second attachment portion.

12. An attachment device comprising:
a first portion comprising a first attachment portion, a first coupling portion housing a first magnet, and a first intermediate portion that forms an opening between the first attachment portion and the first coupling portion; and
a second portion comprising a second attachment portion, a second coupling portion housing a second magnet, and a second intermediate portion that spaces the second attachment portion from the second coupling portion;
wherein the second coupling portion inserts into the opening to couple the second magnet to the first magnet to thereby couple the second portion to the first portion.

13. The attachment device of claim 12, wherein the second attachment portion is positioned below the second coupling portion, the second portion further comprising a decoupling portion comprising an arm that extends outwardly from the second coupling portion.

14. The attachment device of claim 13, wherein the arm is curved upwardly.

15. The attachment device of claim 14, wherein the second intermediate portion is configured to contact the first coupling portion when a downward force is applied to the arm.

16. The attachment device of claim 15, wherein the first and second attachment portions each form a loop.

17. An attachment device comprising:
a first portion comprising a first attachment portion, a first coupling portion, and a first intermediate portion that forms an opening between the first attachment portion and the first coupling portion; and
a second portion comprising a second attachment portion, a second coupling portion, and a second intermediate portion;
wherein the opening is configured to receive the second coupling portion to enable the second coupling portion to couple to the first coupling portion, and wherein the second intermediate portion is configured to receive the first coupling portion when the second coupling portion is coupled to the first coupling portion.

18. The attachment device of claim 17, wherein the first coupling portion includes a first magnet and the second coupling portion includes a second magnet.

19. The attachment device of claim 18, wherein the second portion includes a decoupling portion comprising an arm that causes the second coupling portion to rotate away from the first coupling portion when a force is applied to the arm.

20. The attachment device of claim 19, wherein the arm extends from the second coupling portion.
